(19) United States
(12) Patent Application Publication
(10) Pub. No.: US 2012/0150527 A1
(43) Pub. Date: Jun. 14, 2012

(54) STORAGE PERIPHERAL DEVICE EMULATION

(76) Inventors: Tadhg Creedon, County Galway (IE); Vincent Gavin, Galway (IE); Eugene McCabe, Fremont, CA (US)

(21) Appl. No.: 13/390,787

(22) PCT Filed: Aug. 20, 2010
(86) PCT No.: PCT/IE2010/000052

§ 371 Date: Feb. 16, 2012

Related U.S. Application Data
(60) Provisional application No. 61/235,802, filed on Aug. 21, 2009.

(51) Int. Cl. G06F 9/455

(52) U.S. Cl. 703/24

(57) ABSTRACT

An emulation system (1) comprises a programming system (2) made up of a laptop computer (2(a)) and a central server (2(b)), an interrogation station (3), and a programmable storage peripheral device (4). The system (1) links with an existing disk storage peripheral device (10) to retrieve characterisation data, and upload it to the central server (2(b)). The laptop computer (2(a)) then retrieves the characterization data and then programs the programmable device (4) to emulate the full functionality of the pre-existing computer storage peripheral (10). The device (4) is programmed by the host computer (2) to fully replicate characteristics including electrical and timing characteristics and command responses. The programmable device (4) does not have a disk drive, the only storage components being solid state non-volatile memory components, in this embodiment flash memory and volatile components including DRAM. The flash components include mostly NAND flash, but also NOR flash.

### FIELD OF THE INVENTION

The invention is directed to the field of data storage systems.

### PRIOR ART DISCUSSION

A computer storage peripheral is a device that is connected to a computer system which provides storage space for programs and other information. This includes hard disk drives, solid-state disk drives, CD/DVD storage devices, and tape units. Peripherals may be connected to a computer system via various types of storage interface connections, such as SCSI, SAS, or SATA.

Host computer systems communicate with storage peripherals with software called “drivers”, which are customized to communicate with the particular storage device in use.

Over a period of many years, a very large variety of storage devices, particularly tape units, hard disks and more recently solid-state disks, have been deployed in computer systems worldwide, many performing mission-critical tasks. Hard disks and tape units in particular include moving parts, and regularly require replacement.

The most common method used today in addressing this replacement requirement is to replace a failing peripheral device such as a hard disk with a replica of such a device. This requires maintenance suppliers to keep in stock a large variety of such devices at a significant cost, in order to guarantee fast replacement, thus ensuring continuity of operation of the computer systems dependent on such devices. Often, replicas of original devices can not be sourced, and such computer systems can not be maintained.

Another method used today is handling the replacement of failing older devices based on older technology with new units using current technology. However these are generally not exact replicas of the original device, and typically require changes to the software drivers. This is very often not acceptable to users of mature mission-critical computing systems in view of the risk of inoperability between the computer system, the new drivers, and the new storage peripherals. Another issue is that some computer systems, such as those operating RAID technology, cannot usually handle a mixture of devices with different characteristics.

A method in use to address some, though not all, of the above issues, in particular the issue of obtaining replica storage peripherals for obsolete devices, is to use newer available devices based on current equivalent technology and interfaces, and to convert such interfaces and other characteristics to that of the older device, using suitable additional components. For example, new hard disks could possibly be converted with external components to replicate the functions of older devices. This method has the disadvantage of the added cost of conversion components, and the lack of ability to replicate every parameter of older devices due to the lack of appropriate programming flexibility in the newer devices.

The present invention addresses these issues.

### SUMMARY OF THE INVENTION

According to the invention, there is provided an emulation system for emulating a data processing storage peripheral device, the emulation system comprising:
a programmable storage peripheral device with non-volatile memory, volatile memory, and a control circuit;
an interrogation station adapted to interrogate an existing storage peripheral device,
a programming system adapted to receive from the interrogation station characterization data of an existing storage peripheral device, to re-format said characterization data, and
to program the programmable storage peripheral device with characterization data, and
wherein the programmable storage peripheral device control circuit is adapted to receive said characterization data and to store it for later emulation purposes so that said device emulates the existing storage peripheral device.

In one embodiment, the interrogation station is adapted to retrieve, and the programming system is adapted to program into the programmable peripheral storage device, the following parameters:
electrical and timing characteristics,
command responses,
configuration information including device type and information specifying sectors, cylinders, capacity, platters, heads, and skew,
seek and latency timing information, and
data flow rates.

In one embodiment, the programming system is adapted to map host system logical addresses to physical addresses in the programmable device non-volatile memory.

In one embodiment, the programmable storage peripheral device is adapted to perform frequency-based caching to minimize re-writes to the same non-volatile memory areas, to minimize wear and write amplification.

In one embodiment, the programmable storage peripheral device is adapted to implement a remap table which maps host computer logical addresses to physical addresses in the non-volatile memory.

In another embodiment, the remap table has levels of granularity which are larger or smaller than a non-volatile memory block size so that the remap table size is de-coupled from the capacity of the non-volatile memory.

In one embodiment, the programmable device is adapted to provide a memory size for the remap table so that it has a granularity extending downwards to a point where there is a table entry for every non-volatile memory sector.

In one embodiment, the programmable device includes a cache memory which has a structure with a remap table granularity.

In one embodiment, the programmable device is adapted to, once cache resources are exhausted, perform a write of the sectors involved to the non-volatile memory, and to write a flag to the remap table descriptor that such a write occurred, indicating that this data is in non-volatile memory.

In one embodiment, the programmable device is adapted to create a cache in the form of a ring buffer, to make entries to a head of the ring, and to remove data from a tail of the ring as the buffer becomes close to full or as an impending power-down has been detected.

In another embodiment, a physical address in the remap table refers to either a non-volatile memory address when data is in the non-volatile memory or to a volatile memory address when data is in cache.

In one embodiment, in the case of writes where old data is in the cache, the physical address is used to locate the cache entry such that control flags are marked to invalidate the old cache entries as new entries are made for those logical addresses to the head of the cache.

In one embodiment, if a subsequent write is made to any area within a remap table entry of non-volatile memory which indicates that such area has been previously written at least in part, an entry is made in a descriptor to schedule a future erase operation.

In one embodiment, the programmable device control circuit is adapted to create a per-block usage table with a valid bit per segment in that block to indicate which segment has valid data.

In a further embodiment, an erase-count field is included per block, for use by a wear-levelling algorithm.

In one embodiment, for frequency-based caching the control circuit is adapted to create a table to store the frequency of write accesses to specific logical addresses.

In a further embodiment, the cache data to which the frequency-based table points is either retained in a separate area of volatile memory or combined with the primary cache data, with use of a preserve flag in the primary cache.

In one embodiment, said table is pre-populated with information gained by prior knowledge of an end application.

In one embodiment, the device control circuit is adapted to, as time progresses, keep track of the number of times specific logical segments of memory are written, such that the device over time learns the most popular areas of memory written-to by the end user applications.

In one embodiment, the programmable peripheral device control circuit is adapted to implement a mechanism to drop less-frequently-used addresses of data segments from the frequency-based cache table, and replace them with others based on an ageing mechanism.

In one embodiment, ongoing normalization of frequency numbers in the table is performed to avoid overflows in the case of the highest numbers.

In one embodiment, the programmable device control circuit is adapted to write vital control information including logical addresses and for-erasure and valid flags, to a non-volatile memory spare area as part of normal write operations, coupled with a scan through the spare area following power-up, which may follow either a planned or an unexpected power-down, to re-construct the key remap tables and other vital information.

In another embodiment, the programmable device control circuit is adapted to use sequence-numbering invoked with every normal data write to non-volatile memory, and an associated recovery mechanism, such that the non-volatile memory always contains the most recent information needed to rebuild the complete re-map table after power-down, whether expected or unexpected.

In one embodiment, the programmable device is adapted to use linked-lists of previous mapped addresses and their program/erase-count numbers invoked with every normal data write to non-volatile memory, and an associated recovery mechanism, such that the non-volatile memory always contains the most recent information needed to rebuild the complete re-map table after power-down, whether expected or unexpected.

In one embodiment, the programmable device is adapted to use timestamps invoked with every normal data write to non-volatile memory, and an associated recovery mechanism, such that the non-volatile memory always contains the most recent information needed to rebuild the complete re-map table after power-down, whether expected or unexpected.

In one embodiment, the programmable device is adapted to ensure that every block retains inverse mapping information and to re-build the remap table after power-up, in which no data is written without an associated table entry element, which can be achieved at no additional performance or write endurance penalty.

In one embodiment, recovery of the table includes recovery of information about blocks which were scheduled for erasures but not yet implemented, as well as information about whether or not a block has valid data.

In one embodiment, the interrogation station is adapted to perform interrogation of a legacy storage peripheral device by measuring latency and throughput of existing peripheral storage device responses during interrogation, and the programming system is adapted to use said measurements when programming the programmable peripheral storage device.

In one embodiment, the programming system is adapted to extract parameters from an existing device interrogation response according to rules dedicated to different types of interogation responses, and to use the extracted parameters to perform programming of the programmable device, and wherein the programmable device is adapted to re-create a response from said parameters, said response mimicing the original device response.

In one embodiment, the programming system comprises a programming computer and a physically separate central server, and the central server is adapted to receive and retain characterization data for a plurality of different types of existing storage peripheral device and to download said data upon receipt of a request from the programming computer.

In another aspect, the invention provides a solid state storage device comprising non-volatile memory, volatile memory, and a control circuit, wherein the control circuit is adapted to implement a remap table which maps host computer logical addresses to physical addresses in the non-volatile memory.

In one embodiment, the remap table has levels of granularity which are larger, the same size, or smaller than a non-volatile memory block size so that the remap table size is de-coupled from the capacity of the non-volatile memory, and wherein granularity extends downwards to a point where there is a table entry for every non-volatile memory sector.

In one embodiment, the device includes a cache memory which has a structure with a remap table granularity and is the form of a ring buffer, and is adapted to make entries to the head of the ring, and to remove data from the tail as the buffer becomes close to full or as an impending power-down has been detected, and to perform a write of the sectors involved to the non-volatile memory, and to write a flag to the remap table descriptor that such a write occurred, indicating that this data is in non-volatile memory.

In one embodiment, a physical address in the remap table refers to either a non-volatile memory address when data is in the non-volatile memory or to a volatile memory address (15) when data is in cache, and wherein said physical address is used to locate the cache entry when data is in cache such that control flags are marked to invalidate older cache entries as new entries are made for those logical addresses to the head of the cache.

In one embodiment, if a subsequent write is made to any area within a remap table entry of non-volatile memory which indicates that such area has been previously written at least in part, an entry is made in a descriptor to schedule a future erase operation.

In one embodiment, the device is adapted to create a per-block usage table with a valid bit per segment in that block to indicate which segment has valid data, along with a program/erase-count field for use by a wear-levelling algorithm.

In one embodiment, the device is adapted to write vital control information including logical addresses and for-erasure and valid flags, to a non-volatile memory spare area as part of normal write operations, coupled with a scan through the spare area following power-up, which may follow either a planned or an unexpected power-down, to re-construct the key remap tables and other vital information.

In one embodiment, the device is adapted to use linked-lists of previous mapped addresses and their program/erase-count numbers invoked with every normal data write to non-volatile memory, and an associated recovery mechanism, such that the non-volatile memory always contains the most recent information needed to rebuild the complete re-map table after power-down, whether expected or unexpected.

In one embodiment, the device is adapted to use timestamps or sequence numbers invoked with every normal data write to non-volatile memory, and an associated recovery mechanism, such that the non-volatile memory always contains the most recent information needed to rebuild the complete re-map table after power-down, whether expected or unexpected.

In other aspects, the invention provides a computer readable medium comprising software code for implementing operations of a programming system of an emulation system as defined above in any embodiment.

### DETAILED DESCRIPTION OF THE INVENTION

The invention will be more clearly understood from the following description of some embodiments thereof, given by way of example only with reference to the accompanying drawings in which:

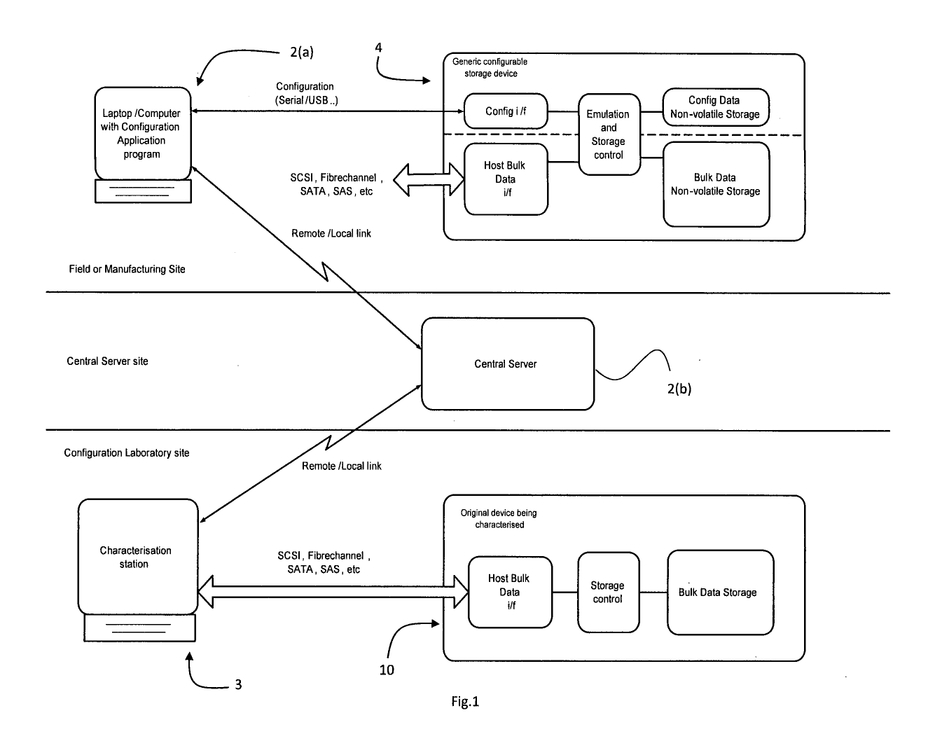

FIG. 1 is a block diagram illustrating a system for automated emulation of computer storage peripheral devices;

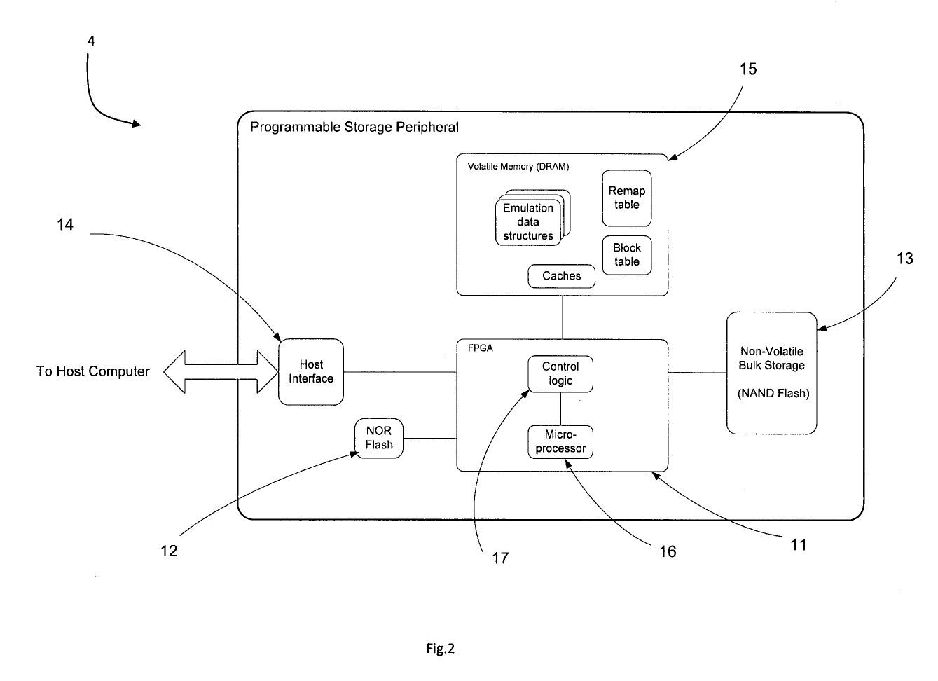

FIG. 2 is a diagram illustrating a programmable storage peripheral device of the system in more detail;

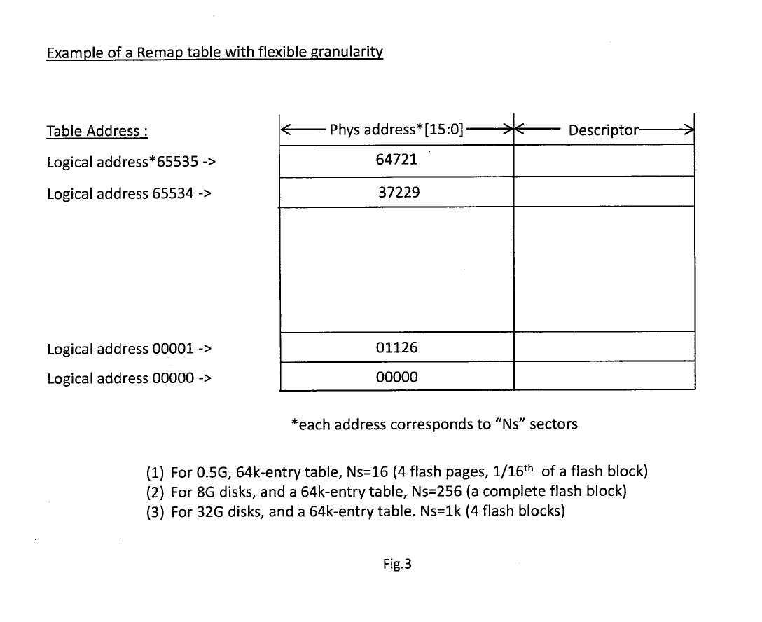

FIG. 3 is a sample remap table used by the system, in particular being part of the core functionality of the programmable device to emulate a storage peripheral;

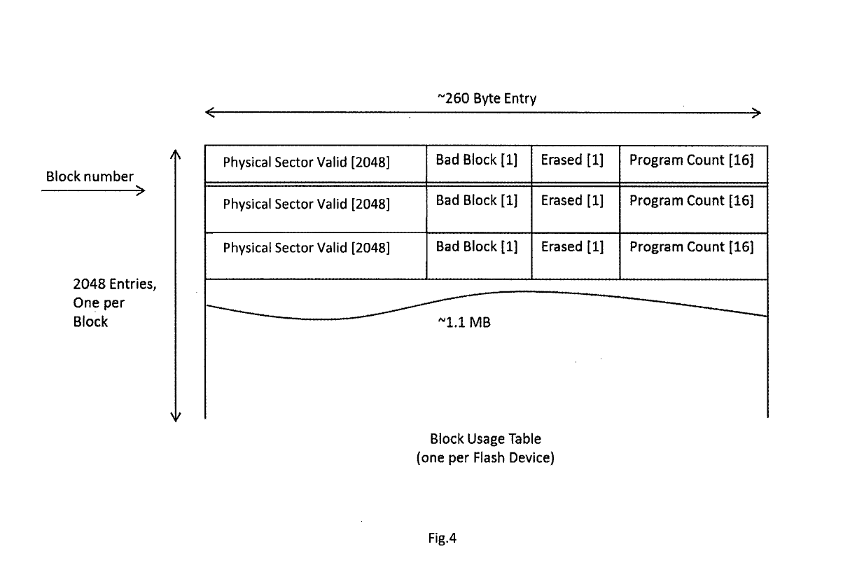

FIG. 4 is a sample block usage table of the programmable device;

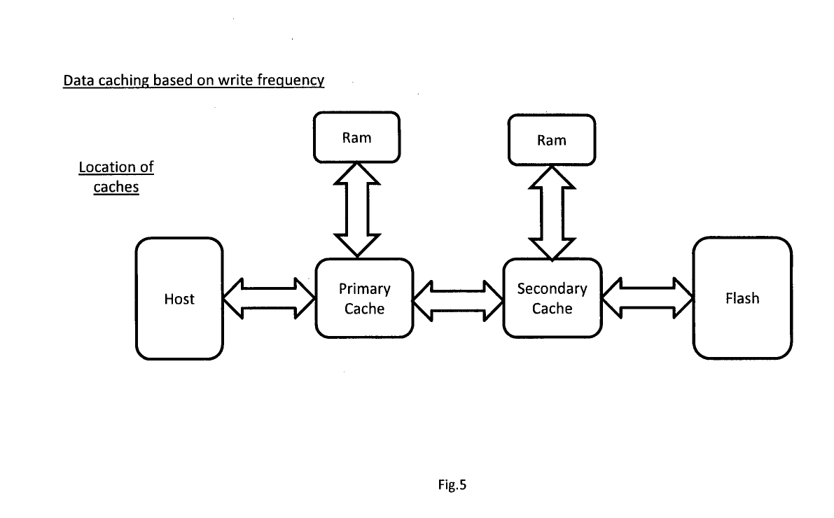

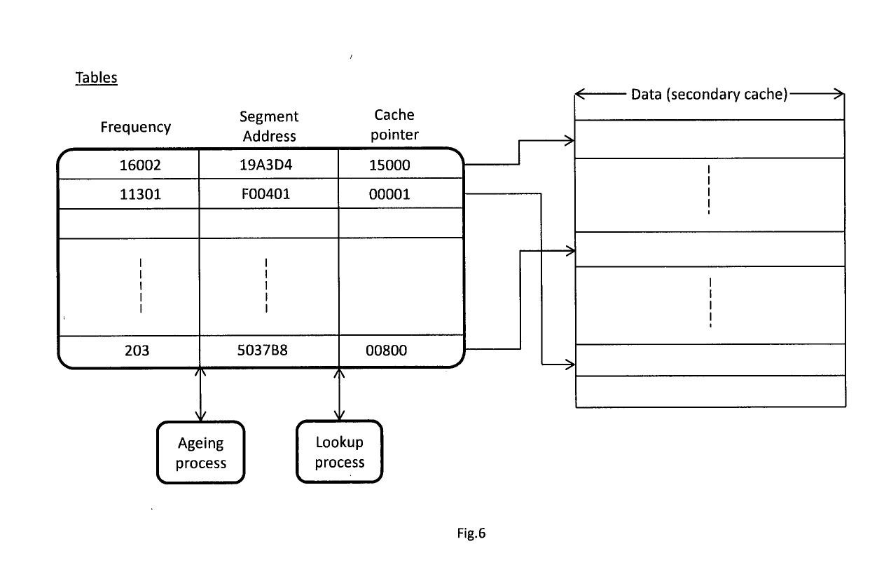

FIGS. 5 and 6 show data caching of the programmable device; and

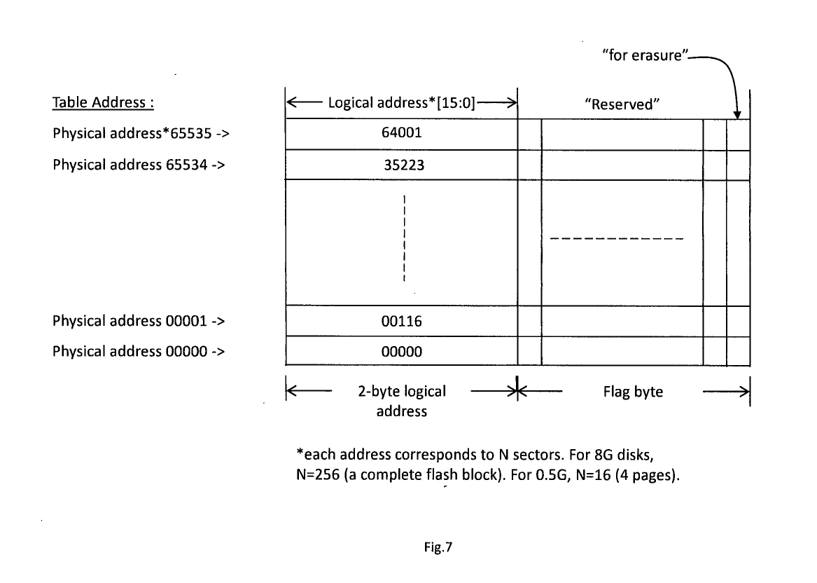

FIG. 7 is a sample table for physically addressed remap lookup of the programmable device.

### DESCRIPTION OF THE EMBODIMENTS

FIG. 1 is a high-level block diagram of an emulation system 1 of the invention. It comprises a programming system 2 made up of a laptop computer 2(a) and a central server 2(b), an interrogation station 3, and a programmable storage peripheral device 4.

The system 1 in use links with an existing disk storage peripheral device 10 to retrieve characterisation data, and upload it to the central server 2(b). The laptop computer 2(a) then retrieves the characterization data and then programs the programmable device 4 to emulate the full functionality of the pre-existing computer storage peripheral 10. The device 4 is programmed by the host computer 2 to fully replicate the:
electrical characteristics
the timing characteristics
the command responses
reported configuration information including but not limited to:
   device type, such as disk, tape and so on
   sectors, cylinders, capacity, platters, heads, and skew,
seek and latency timing, and
data flow rates.

Referring to FIG. 2, the programmable device 4 does not have a disk drive, the only storage components being solid state non-volatile memory components, in this embodiment flash memory and volatile components including DRAM. The flash components include mostly NAND flash, but also NOR flash. In FIG. 2 the FPGA is shown as 11, NOR flash (primarily for boot-up and configuration) as 12, bulk NAND flash as 13, an interface to the host as 14, and DRAM as 15.

The device 4 programming can be performed in the factory, the supply depot, or at the customer site by a service engineer using a device such as a laptop computer. This will allow the stocking of a generic device and the postponement of its configuration until it is required in the field. This eliminates the need to stock large numbers of different part numbers and configuration of the pre-existing parts for use by service organisations.

In summary, the system 1 provides (a) a device (4) incorporating non-volatile solid-state technology along with the ability to be programmed to exactly emulate all aspects of a very wide variety of storage devices deployed in computer systems today, coupled with (b) a station (3) which interrogates all discernable parameters of existing units, coupled also with (c) a programming system (2) which programs the solid-state device with all such parameters. This coupling of these three elements achieves the major benefits of versatility in the field, allowing the device (4) to be used instead of need to keep a supply of particular peripheral devices.

The system 1 includes the following advantageous functionality:
Replication of any of a range of existing disk or tape storage peripheral devices using a programmable flash-based non-volatile storage device.
Emulation of hard disk storage characteristics using flash memory technology. This includes mapping flash memory to segments/sectors in hard disks, using frequency-based caching techniques to minimize re-writes to the same flash areas, to minimize wear and write amplification, and emulation of hard disk characteristics in recovery from unexpected power-downs

The central server 2(b) decouples the interrogation and programming tasks. From a practical viewpoint, these tasks are unlikely to be performed in situ. More often, the tasks involved will be separated in time and by geography. Hence, a large range of existing devices will be characterised ahead of the need to replicate them, and all relevant parameters stored on the central server 2(b), as well as potentially on a distribution medium for convenient application in the field, such as with a laptop computer.

Also, programming of the device 4 to emulate the original storage device 10 may be done in a manufacturing location in high volume, with appropriate secure information systems available with access to a database of device characteristics. Additionally, this programming will often be accomplished in field locations via remote access with appropriate authentication. The following are the major steps in operation of the system 1:
A software program will allow the user to select a disk (that has previously been characterised) from a list, and program the device 4.
The program first records the serial number of the device 4, details of the programmer, the date, and other information.
It then can optionally perform serial number checking to verify valid serial numbers.

It then contacts the central server 2(b) (whether locally or remotely) and sends identification information encrypted to the central server 2(b), such as the local computer 2(a) MAC address or equivalent identification number.
When authenticated, it checks for updates to “Parameter files” and downloads new files if it is necessary. All such communications may be encrypted.
It may also check the revision of the program being used, and download a new version of that if appropriate.
It reads the appropriate “Parameter file” for the device being emulated, decrypts it, and programs the device 4, typically via a serial interface (FIG. 1).
It reads the date it last successfully connected to the central server 2(b) and displays the remaining time to function without another such access. This ensures that parameters and programs are constantly refreshed, and helps in timing-out any unauthorised accesses.
It keeps a log file of the transactions.

Electrical and Timing characteristics:

Electrical characteristics such as impedance matching and bus interface timing characteristics are emulated using input/output cells of the FPGA 11.

Command responses:

The programming system (2) extracts parameters from a legacy device interrogation response according to rules dedicated to different types of interogation responses, and uses the extracted parameters to perform programming of the programmable device. The programmable device 4 re-creates a response from these parameters, which response mimics the legacy device response.

Although certain commands are specified by standards bodies such as the Small Computer System Interface (SCSI) Trade Association, many commands have vendor-specific and device-specific responses. For example, commands such as “READ CAPACITY” will yield a range of responses across all manufacturers and their individual products. To emulate these exactly, the existing devices are interrogated by the interrogation station 3, their responses analysed and cataloged, and later programmed into the device 4 based on solid-state storage technology. The subject of this command (which may be the actual capacity of the storage device) is emulated exactly. This is achieved by the device 4 having the same or somewhat larger storage capacity than the device 10 being emulated, firstly by artificially limiting the amount of solid-state storage accessible to users to exactly match the capacity of the device 10 being emulated, and secondly by returning the exact same response to the “READ CAPACITY” command, such that a host system which will use the programmed device 4 cannot distinguish between the original device 10 and the device 4.

Other commands are implemented by directly mimicing the responses detected using the interrogation station 3, even if they have no real meaning in a solid-state system. Examples are number of sectors, cylinders, capacity, platters, heads, skew and various other relevant parameters. Even though they have no real meaning, they must be emulated exactly such that a host system driver will believe it is communicating with the original device 10. Otherwise, such drivers would need to be modified, and this is not feasible in many situations where it is not acceptable for risk and disruption purposes to change system software. For these commands, data structures holding such responses are firstly stored in the NOR flash non-volatile memory 12, retrieved following power-up and placed in emulation data structures in the DRAM system memory 15, and with the aid of the FPGA 11 embedded microprocessor, formatted into the correct command responses expected by the host driver, and returned to the host via the system bus such as SCSI and the host interface 14.

Seek (latency) Timing and Data Flow Rates:

Because of global nature of the distribution of existing storage devices and their drivers, it would not be feasible to analyse the characteristics of all existing drivers to ensure 100% compatibility with emulated disks. Some drivers may depend on expected latencies in accessing data held on older technology such as hard disks. Hard disks for example have an unavoidable “seek” time, caused by the time it takes for disk heads to physically move to the sector being read or written. Because newer solid-state storage technology is faster by nature as it has no such moving parts, data is normally available more quickly than with older devices. Returning data more quickly than expected may cause errors with existing drivers which may have a dependency on longer latencies for example to complete other computations ahead of data being available. The interrogation station 3, in addition to acquiring command responses, measures latencies in accessing data, by measuring the time between data requests and responses. These are also cataloged and programmed into the emulation device 4 along with command responses. The microprocessor in the emulation device 4 emulates these latencies by artificially adding time to the latency in accessing solid-state storage memory before returning a response to the host following a host data command.

Also, in solid-state disk systems based on flash memory, a key requirement is to avoid constantly writing to the same memory areas, thereby wearing down those flash blocks and reaching their life expectancy in a relatively short period. Wear-levelling techniques are known, whereby regularly-used blocks of flash memory are exchanged with rarely-used locations, and such exchanges are recorded in a remap table. The net effect is that flash blocks in the overall system often wear down evenly. However, if such prior art techniques were to be used in the system 1 there would be a problem in some situations as the remap tables would be out of scale in relation to the capacity of the disk being emulated.

In addition, a problem known as “write amplification” becomes more problematic for small systems—this is where a write to even a small percentage of a block requires a write to a new block and a copy operation of all other data from the previous to the new block, and finally an erase of the old block. As a full block represents a significant percentage of available memory in a small device, this has a negative impact on write performance.

Typically writing the remap table to a non-volatile storage area prior to power-down is achieved by detecting an impending power-down, and retaining power on the storage system for a certain period of time as required to save the table in non-volatile memory. This is typically achieved at additional cost to the system, via additional components such as super-capacitors or batteries and associated components, to supply temporary power when the power supply is removed. This is not always optimal such as when there is a requirement to develop low-cost storage systems.

Mapping Flash Memory to Segments/Sectors in Hard Disks

The device 4 includes a mechanism in the FPGA microprocessor 16 and the control logic 17 whereby the effectiveness of wear-levelling and write amplification of flash-based memory systems is optimised to match the resources available for remap or “translation” table requirements. For limited-size flash-based memory systems, this technique enhances the lifetime of flash memory as used in read/write applications, and reduces the negative impact of write amplification effects, by reducing the granularity of remap table entries to a finer level than the prior common approach of using the normal flash block size, often fixed at 128 kBytes or 256 kBytes. For larger flash-based memory systems, the technique reduces the resources required for remap table purposes, by increasing the entry size of remap tables to a coarser level than the fixed flash block size.

The resources required to handle small through large flash memory sizes therefore remains constant, greatly facilitating the design of a single controller covering a large range of applications while yielding a consistent wear levelling and write amplification performance across the range.

The flash block size may be decoupled from the size of a remap table to create an effective means to manage small flash memory systems. A second benefit of the technique offers advantages in larger systems also, whereby the granularity may be set at a level greater than block size. In this case, the remap table can be limited to a cost-effective size, reducing the silicon and memory area needed to store the remap table.

FIG. 3 shows an example of a remap table whereby logical addresses are those issued by a host computer, and physical addresses are those in flash memory, having been remapped to any location based on a wear-levelling algorithm. The example refers to three cases (1) granularity at a fine level, useful for small systems, (2) granularity where remap table entries correspond to flash block sizes—this is the granularity normally used today, and (3) granularity where remap tables refer to more than a single flash block. This flexible granularity allows for close-to-constant wear-levelling and write-amplification performance for a fixed table size (and hence silicon and control memory cost), across a wide range of total flash memory system sizes. This allows system designers to calculate an acceptable performance for the above parameters, allocate silicon and control memory resources for remap table entries accordingly, and without changing such control silicon and associated control memory, provide for a range of flash-based memory sizes with similar performance levels across the entire range. In FIG. 3 there is an example for a 64 k-entry table, for a number of flash memory sizes. The general case is as follows:

Tb=Table resources in total bytes

Eb=Entry (in table) size in bytes

Ss=Sector size, typically 512 bytes (=2**9 Bytes)

Mt=Memory (flash) size total in bytes

For a flash memory system controller design targeted at a particular market area in terms of ranges of flash memory size, e.g. 0.5G to 32G, it is convenient to fix the total resources for the remap table in Bytes, and thereby facilitate the design of a single controller to handle the targeted memory range.

For a fixed table size in Bytes, Tb, to determine the granularity in number of “sectors” per entry, the following equations are used:

Sm=Mt/Ss (Number of sectors in memory system),

Ts=Tb/Eb (Table size in number of remap entries),

Ns=Sm/Ts (Number of “sectors” represented per table entry),

Or, for a single overall equation, Ns=(Mt/Ss)/(Tb/Eb)=(Mt.Eb)/(Ss.Tb).

Comparing with the examples in FIG. 3, for the three cases, assuming for this example that Eb=4 (=2**2) bytes, and Tb=256 k (=2**18) bytes, and Ss=512 (=2**9) bytes:

(1) 0.5G system : Mt=0.5G (i.e. 2**29 bytes), so Ns=(2**29*2**2)/(2**9*2**18)=2**(29+2−9−18)=2**4=16 sectors ( 1/16^{th} of a 128 kbyte flash “block”)

(2) 8G system: Mt=8G (i.e. 2**33 bytes), so Ns=(2**33*2**2)/(2**9*2**18)=2**(33+2−9−18)=2**8=256 sectors (a single 128 kbyte flash “block”, the “normal” case)

(3) 32G system: Mt=32G (i.e. 2**35 bytes), so Ns=(2**35*2**2)/(2**9*2**18)=2**(35+2−9−18)=2**10=1024 sectors (four 128 kbyte flash “blocks”)

Note that, depending on the memory size available for the remap table, granularity can extend downwards to the point where there is a table entry for a single 512-byte sector.

A cache memory is utilized in conjunction with the remap table mechanism.

In the device 4, the cache size needs only to match the granularity of the remap table, thus enabling a cache size which is smaller than a block, resulting in a small silicon or memory area for low-cost implementations. Alternatively, where larger volatile memory resources (15) are available in the programmable device 4, this enables the storing of multiple remap table entries in a memory cache, thus minimizing the number of actual flash writes required and maximizing the effectiveness of the wear-levelling algorithm.

Depending on the non-volatile memory resources 15 available in the device 4, and the time available on impending power-down to store away data, the larger the cache, the more effective it is in minimizing writes to flash and thereby minimizing flash wear-out.

Therefore, the decision on non-volatile memory 15 size in the device 4 is a trade-off between cost and performance (throughput and flash wear-out).

Once cache resources are exhausted in the case of cache write mismatches, or once a full area corresponding to a remap table entry is filled, a write is performed to the cache of the sectors involved, and flags noted in the remap table's descriptor that such a write occurred, indicating the location of this data (flash or cache—or the default of “not yet written”).

The method of organizing such a cache is to create a ring buffer in volatile memory, such as DRAM 15. Cache entries are made to the head of the ring, and data is removed from the tail to write to flash as the buffer becomes close to full, or an impending power-down has been detected. In the case of data being in DRAM 15, the “Physical address” in the remap table of FIG. 3 can instead refer to the volatile memory address in the data cache. In this way, it can be located instantly, both for data retrieval for “Reads”, and in the case of “Writes” for marking control flags to invalidate older cache entries as new entries are made for those logical addresses to the head of the cache ring buffer.

If a subsequent write is made to any area within a remap table entry of flash memory which indicates that such area has been previously written at least in part, an entry can be made in the descriptor to schedule a future erase operation.

A per-block “usage” table can be created, with a “valid” bit per segment in that block to indicate which segment has valid data. This makes it convenient to decide which blocks to schedule for copying to new blocks prior to erasure, those with fewer segments used being preferred—as long as their previous “Erase-count” values are comparable with other choices of blocks for erasure. To enable this, in addition to “valid” bits per segment, a large “Erase-count” (or “Program count”) field should be included per block, for use in wear-levelling algorithms. Additional flags can be included as needed, such as a “Bad Block” indication.

FIG. 4 shows such a per-block table. The “segment” size is set to the minimum value of a single sector, resulting in a large table.

To complement wear-levelling techniques, and further extend the lifetime of non-volatile memory of the device, writes to regularly accessed areas of logical memory can be further reduced by use of frequency-based caching mechanisms. This contributes to improved performance.

The system incorporates a frequency-based data caching mechanism for use with flash memory-based storage systems, whereby the decision as to which areas of overall memory space to allocate to cache is based on historical information regarding the frequency of accesses to particular blocks of memory. The effect is a significant reduction of the number of accesses to particular areas of flash, to complement other “wear-levelling” algorithms, aimed at prolonging the lifetime of the memory 13, which are limited to a finite number of write and read cycles over their lifetimes.

FIGS. 5 and 6 show deployment of two caches (primary and secondary) tailored at flash-based storage systems. The primary cache is used to store new write data as it arrives from the host system, and retrieve recently-written data to return to the host system. This reduces flash memory writes and reads, reducing flash wear-out and improving performance. A “secondary” caching mechanism based on frequency of accesses is deployed to further minimize flash writes and reads and thereby increase its lifetime. This may be located between the above cache, referred-to here as a “primary” cache, and the actual flash memory.

Both caching operations may be combined into a single function, where an additional “preserve” flag can be added to preserve frequently-used data (even if not recently used) in the ring-buffer cache.

Referring to FIGS. 5 and 6, a table is created to store the frequency of write accesses to specific logical addresses, with a granularity of either a flash block (if the “secondary ” cache is implemented as an independent cache to the “primary” cache), or a granularity based on a remap table entry, if implemented via a combined function. Initially, this table may be empty, or may be pre-populated with information gained by prior knowledge of the end application. As time progresses, the caching function keeps track of the number of times specific logical segments of memory are written, such that the system over time learns the most popular areas of memory written to by the end user application, typically characterized by the particular operating system implemented in the host computer. Volatile storage, such as that based on DRAM technology, is made available to the secondary caching function to store data indefinitely for the most commonly written areas of memory. Prior to losing power, an early warning mechanism may be used to store the contents of the secondary cache into flash, before power is removed.

In due course, some areas of cached memory become less frequently written than others, as a result of changed circumstances, such as upgrade or replacement of a host's operating system, changed end-user applications, removal of the storage device and installation in a different system, and so on. It may also be decided to not retain in flash memory the table's frequency information following each power-down, in which case re-learning of its contents will be required following power-up. In each of the above scenarios, a mechanism is needed to drop less-frequently-used addresses of data segments from the frequency table, and replace them with others. This may be conducted based on either actual frequency, or a combination of this and an ageing mechanism, where frequency field for example could be regularly counted down until it expires.

This avoids large but irregular write bursts to a particular location permanently using up a location in the frequency table, and favours instead more recently used popular locations.

Ongoing normalization of the frequency numbers in the table is needed to avoid overflows in the case of the highest numbers. In addition, a simple linear scheme for frequency numbers may be appropriate depending in the application, or to combat large ranges in frequencies between segments, a logarithmic or other non-linear scheme may be appropriate.

Recovery From Unexpected Power-Downs

The device 4 depends on the existence of a remap table held in volatile memory 15 during normal operation, for efficiency of accesses to the table. This poses a challenge in the event of an unplanned power-down of the device. If re-map details are lost, data is likely to be unrecoverable.

In a planned power-down sequence, such as following an indication from a host processor that a power-down sequence is imminent, it is often possible to store remap tables and other useful information in non-volatile memory before power-down. However, as noted above this is not always feasible, such as in the case of an unexpected unplugging of a cable. In the device 4 the normal action of writing regular data to flash memory is complemented with additional information written to enable subsequent recovery of the remap table after power-up. The device 4 writes vital control information in flash memory “spare area” (which is available on typical flash memory components) as part of normal write operations, coupled with a scan through such “spare area” following power-up, which may follow either a planned or an unexpected power-down equally, to re-construct the key remap tables and other vital information.

The device 4 uses linked lists and sequence numbering invoked with every normal data write to flash, and an associated recovery mechanism, such that flash memory always contains the information needed to rebuild the complete remap table after power-down, whether expected or unexpected.

The device 4 stores the remap table in “spare bytes” available per flash sector which are provided in most flash memory chips available today, where each flash data write also updates a remap table recreation element in real time. Recovery is via a scan through flash reading the spare bytes throughout flash and recreating the remap table on power-up. Recovered information also includes information about blocks which were scheduled for erasure but not yet implemented, as well as information about whether or not a block has valid data.

By retaining the remap information in the same block as the data being written, rather than being in a separate block, no penalty is incurred as regards the cost of such writes from the viewpoint of write endurance. Having the remap table information distributed in flash avoids wear problems which would arise if it were written to specific flash blocks.

Referring to FIG. 7 the following algorithm describes a mechanism for data writes to flash, including how the remap table recovery information is stored while writing.

The device 4 determines that a write to flash is required, for example in storing to flash data previously held in a data cache. It then writes the data to the flash including the following spare bytes in a “base sector” of this segment in flash:
the logical address corresponding to the physical address of this segment, and
further identification bytes to validate this as the latest mapping for the logical address.

It is necessary to store such identification information to ensure the latest mapping of a logical address is used. Following several remapping steps, more than one physical segment will correspond to the same logical segment in flash when examining the spare bytes during recovery from power-down. Therefore, when recovering the table after power-up, a recovery algorithm will need to know which to use. Various methods may be used to handle this, such as:

(a) Use a large time-stamp (3 bytes), with a roll-over period of for example two hours, and use a background software algorithm to erase/copy blocks with older timestamps to avoid roll-over. Then use the version with newest timestamp after power-up.

(b) Same as above, but use a 3-byte sequence number instead of a timestamp, incrementing each remap. In the lifetime of the device 4, a 3-byte sequence number will not roll over.

(c) Use the program/erase count (3 bytes) of the old physical segment which uniquely identify it, to a spare area of the new segment. The old physical address from the table lookup is known, therefore a lookup of program/erase-count table in local memory recovered first from flash after power-up determines the latest version.

Of these choices, the latter option is described in more detail below:
Say physical segment A was written with data for logical segment W. Assume this is the first time A was used.
The “old physical address” and “old erase-count” bytes remain at default of all “f”s. Because as we won't ever have a 24-bit physical address of ffffff in an 8G system, this will not be mistaken for a real address.

If no further movement takes place, this is easily recognised as unique.
Later new data needed to be written to one or more of the same logical segments in W, so when A is checked, the clash is detected, and a new physical segment for W is taken from the free pool, physical address B. The data is written to the new physical segment B, and physical address A is written to B's “old” physical address field, along with A's block erase-count.
Having remapped logical address W to physical segment B, and written W to the “current logical address” field in B, we now have two segments with W as it's logical address, and need to know which is more recent. By writing the old physical address A and its erase-count (say “5”) we can identify B as W′s most recent physical address, as no other physical segment has an “old pointer” to B.
Assume it happens a few more times, with W moving next to C (with B as the old physical address), and then on to D (with C as the old address). Now A gets erased, and happens to be picked as W′s next destination, with the updated A having an “old physical address” pointer to D. Now we have a loop, with B still pointing to A, C to B, D to C, and A to D. So we need to distinguish A as the most recent physical address for W.
This can be done by also storing the program/erase-count of the overall block containing the segment with the old physical address. So, for example when W moved to B, it stored old physical address A with an erase-count of 5. Later the block with A got erased, and when it re-appeared it had an erase-count of at least 6. The above loop can be broken by disregarding the entry for “old physical address”=A with erase-count “5” in the loop, as there's a “6” elsewhere, which means that it is known that the entry for B pointing to A is old. This leaves A as the only one with no other segment pointing to it, i.e. the most recent. Program/erase-count is two to three bytes (FIG. 7), the number of bytes chosen such that it never rolls over in the lifetime of the device 4.

Initialisation: at manufacturing time, all blocks will have been erased with spare bytes generally reading “FF”, which allows software to not include them when re-creating the remap table. Some blocks will have been marked as bad blocks (non-“FF” in a particular spare byte). Some blocks will have been programmed at the disk emulation system manufacturing site with initial data, along with spare bytes programmed appropriately. This will ensure the first power-up after manufacturing acts in the same way as any subsequent ones, including re-creation of a remap table.

On power-up a software algorithm scans “base sectors” in flash reading these spare bytes, and creates the remap table, with the only “valid” entries being those corresponding to data written to flash in manufacturing. Most flash segments will default to being “unwritten” (all “f”s) and will be as a result be entered in the free FIFO. “Base sectors” means those sectors in a block which are the first sectors in a block to be written after erasure, or for the first time.

The “valid” and “for_erasure” flags need to be recovered along with the logical to remapped addresses.

The “for_erasure” flag which is relevant to physical segments, can be recovered during the recreation of the remap table, by noting any physical blocks which have a real logical address (i.e. not all f's), e.g. “W” in the earlier example, but are not the top of the tree for this logical address. Any other blocks were either never used, or were already erased.

The “valid” flag, which is relevant to logical segments, can also be recovered during this process, being set to “1” for any logical address, e.g. W, emerging from the re-map process. All other logically-addressed table entries, i.e. without valid physical addresses, should have valid=0 by default.

When the above process is completed, any physical blocks which don't appear in the logical table (FIG. 3) with “valid” set, or which don't appear in the physical table (FIG. 6) with “for_erasure” set, and which are not from a block with a “bad block” indication, are available for new data writes, e.g. by entering them on a “free block list”.

The block erase-count table mentioned earlier can be loaded from the block erase-count table stored directly in flash on a regular basis (see below). Any anomalies caused by unplanned power-downs resulting in this table being slightly outdated versus the erase-counts detected in during the re-map algorithm, can be adjusted after re-loading the erase-count table. 100% accuracy is not important for erases, although it's important that there's consistency from the viewpoint of the algorithm to recover the re-map table.

### Example Spare Byte Allocation

The following summarises a suggested use of “spare bytes” to implement the above techniques. Even though only some sectors have only a subset of these bytes allocated, it's easier to avoid re-using the equivalent bytes in other sectors for different purposes. In total we have 16 spare bytes per sector:
Byte 0: bad block indication.
Bytes 1,2: current logical segment number.
Bytes 3-5: physical address of previous segment to be assigned to the above logical segment number.
Bytes 6-8: erase-count of block containing the above previous segment.
Byte 9: written indication (ff=not written, 00=written).
Byte 10: index.
Byte 11: base address.
Bytes 15 to 12: ECC for data and above bytes (includes extra 8 bits for possible expansion beyond a 24-bit ECC).

The intention is to prepare, then write all 528 bytes (16 spare, 512 data) together.

The invention is not limited to the embodiments described but may be varied in construction and detail. For example, the features of the device 4 may be provided in a solid state storage peripheral which is not emulating a legacy peripheral. Also, while the programmable device 4 includes flash memory as the non-volatile solid state memory, this could also be any non-volatile memory including but not limited to Magneto-Resistive Random Access Memory, Ferroelectric Random Access Memory, Phase Change Random Access Memory, Spin-Transfer Torque Random Access Memory, and Resistive Random Access Memory. In addition, in some circumstances hard disk technology based on newer more reliable lower-cost techniques can be used effectively as non-volatile storage technology within the emulation device 4.

1. An emulation system for emulating a data processing storage peripheral device, the emulation system comprising:
a programmable storage peripheral device with non-volatile memory, volatile memory, and a control circuit;
an interrogation station adapted to interrogate an existing storage peripheral device,
a programming system adapted to receive from the interrogation station characterization data of an existing storage peripheral device, to re-format said characterization data, and to program the programmable storage peripheral device with characterization data, and
wherein the programmable storage peripheral device control circuit is adapted to receive said characterization data and to store it for later emulation purposes so that said device (4) emulates the existing storage peripheral device
wherein the interrogation station is adapted to retrieve, and the programming system is adapted to program into the programmable peripheral storage device, the following parameters:
electrical and timing characteristics,
command responses,
configuration information including device type and information specifying sectors, cylinders, capacity, platters, heads, and skew,
seek and latency timing information, and data flow rates;
wherein the programming system is adapted to map host system logical addresses to physical addresses in the programmable device non-volatile memory;
wherein the programmable storage peripheral device is adapted to implement a remap table which maps host computer logical addresses to physical addresses in the non-volatile memory;
wherein the interrogation station is adapted to perform interrogation of a legacy storage peripheral device by measuring latency and throughput of existing peripheral storage device responses during interrogation, and the programming system is adapted to use said measurements when programming the programmable peripheral storage device; and
wherein the programming system comprises a programming computer and a physically separate central server, and the central server is adapted to receive and retain characterization data for a plurality of different types of existing storage peripheral device and to download said data upon receipt of a request from the programming computer;

2. (canceled)

3. (canceled)

4. The emulation system as claimed in claim 1, wherein the programmable storage peripheral device is adapted to perform frequency-based caching to minimize re-writes to the same non-volatile memory areas, to minimize wear and write amplification.

5. (canceled)

6. The emulation system as claimed in claim 1, wherein the remap table has levels of granularity which are larger or smaller than a non-volatile memory block size so that the remap table size is de-coupled from the capacity of the non-volatile memory;
and wherein the programmable device is adapted to provide a memory size for the remap table so that it has a granularity extending downwards to a point where there is a table entry for every non-volatile memory sector.

7. (canceled)

8. The emulation system as claimed in claim 1, wherein the programmable device includes a cache memory which has a structure with a remap table granularity;
and wherein the programmable device is adapted to, once cache resources are exhausted, perform a write of the sectors involved to the non-volatile memory, and to write a flag to the remap table descriptor that such a write occurred, indicating that this data is in non-volatile memory.

9. (canceled)

10. The emulation system as claimed in claim 1, wherein the programmable device is adapted to create a cache in the form of a ring buffer, to make entries to a head of the ring, and to remove data from a tail of the ring as the buffer becomes close to full or as an impending power-down has been detected.

11. The emulation system as claimed in claim 1, wherein a physical address in the remap table refers to either a non-volatile memory address when data is in the non-volatile memory or to a volatile memory address when data is in cache;
and wherein in the case of writes where old data is in the cache, the physical address is used to locate the cache entry such that control flags are marked to invalidate the old cache entries as new entries are made for those logical addresses to the head of the cache.

12. (canceled)

13. The emulation system as claimed in claim 1, wherein if a subsequent write is made to any area within a remap table entry of non-volatile memory which indicates that such area has been previously written at least in part, an entry is made in a descriptor to schedule a future erase operation.

14. The emulation system as claimed in claim 1, wherein the programmable device control circuit is adapted to create a per-block usage table with a valid bit per segment in that block to indicate which segment has valid data;
and wherein an erase-count field is included per block, for use by a wear-levelling algorithm.

15. (canceled)

16. The emulation system as claimed in claim 1,
wherein the programmable storage peripheral device is adapted to perform frequency-based caching to minimize re-writes to the same non-volatile memory areas, to minimize wear and write amplification; and
wherein for frequency-based caching the control circuit is adapted to create a table to store the frequency of write accesses to specific logical addresses.

17. The emulation system as claimed in claim 1,
wherein the programmable storage peripheral device is adapted to perform frequency-based caching to minimize re-writes to the same non-volatile memory areas, to minimize wear and write amplification; and wherein for frequency-based caching the control circuit is adapted to create a table to store the frequency of write accesses to specific logical addresses; and
wherein the cache data to which the frequency-based table points is either retained in a separate area of volatile memory or combined with the primary cache data, with use of a preserve flag in the primary cache.

18. The emulation system as claimed in claim 1,
wherein the programmable storage peripheral device is adapted to perform frequency-based caching to minimize re-writes to the same non-volatile memory areas, to minimize wear and write amplification; and wherein for frequency-based caching the control circuit is adapted to create a table to store the frequency of write accesses to specific logical addresses; and
wherein said table is pre-populated with information gained by prior knowledge of an end application.

19. The emulation system as claimed in claim 1,
wherein the programmable storage peripheral device is adapted to perform frequency-based caching to minimize re-writes to the same non-volatile memory areas, to minimize wear and write amplification; and
wherein for frequency-based caching the control circuit is adapted to create a table to store the frequency of write accesses to specific logical addresses; and
wherein the device control circuit is adapted to, as time progresses, keep track of the number of times specific logical segments of memory are written, such that the device over time learns the most popular areas of memory written-to by the end user applications.

20. The emulation system as claimed in claim 1,
wherein the programmable storage peripheral device is adapted to perform frequency-based caching to minimize re-writes to the same non-volatile memory areas, to minimize wear and write amplification; and
wherein the programmable peripheral device control circuit is adapted to implement a mechanism to drop less-frequently-used addresses of data segments from the frequency-based cache table, and replace them with others based on an ageing mechanism; and
wherein ongoing normalization of frequency numbers in the table is performed to avoid overflows in the case of the highest numbers.

21. (canceled)

22. The emulation system as claimed in claim 1,
wherein the programmable device control circuit is adapted to write vital control information including logical addresses and for-erasure and valid flags, to a non-volatile memory spare area as part of normal write operations, coupled with a scan through the spare area following power-up, which may follow either a planned or an unexpected power-down, to re-construct the key remap tables and other vital information.

23. The emulation system as claimed in claim 1,
wherein the programmable device control circuit is adapted to write vital control information including logical addresses and for-erasure and valid flags, to a non-volatile memory spare area as part of normal write operations, coupled with a scan through the spare area following power-up, which may follow either a planned or an unexpected power-down, to re-construct the key remap tables and other vital information; and
wherein the programmable device control circuit is adapted to use sequence-numbering invoked with every normal data write to non-volatile memory, and an associated recovery mechanism, such that the non-volatile memory always contains the most recent information needed to rebuild the complete re-map table after power-down, whether expected or unexpected.

24. The emulation system as claimed in claim 1,
wherein the programmable device control circuit is adapted to write vital control information including logical addresses and for-erasure and valid flags, to a non-volatile memory spare area as part of normal write operations, coupled with a scan through the spare area following power-up, which may follow either a planned or an unexpected power-down, to re-construct the key remap tables and other vital information; and
wherein the programmable device is adapted to use linked-lists of previous mapped addresses and their program/erase-count numbers invoked with every normal data write to non-volatile memory, and an associated recovery mechanism, such that the non-volatile memory always contains the most recent information needed to rebuild the complete re-map table after power-down, whether expected or unexpected.

25. The emulation system as claimed in claim 1,
wherein the programmable device control circuit is adapted to write vital control information including logical addressed and for-erasure and valid flags, to a non-volatile memory spare area as part of normal write operations, coupled with a scan through the spare area following power-up, which may follow either a planned or an unexpected power-down, to re-construct the key remap tables and other vital information; and
wherein the programmable device is adapted to use timestamps invoked with every normal data write to non-volatile memory, and an associated recovery mechanism, such that the non-volatile memory always contains the most recent information needed to rebuild the complete re-map table after power-down, whether expected or unexpected.

26. The emulation system as claimed in claim 1
wherein the programmable device control circuit is adapted to write vital control information including logical addresses and for-erasure and valid flags, to a non-volatile memory spare area as part of normal write operations, coupled with a scan through the spare area following power-up, which may follow either a planned or an unexpected power-down, to re-construct the key remap tables and other vital information; and
wherein the programmable device is adapted to ensure that every block retains inverse mapping information and to re-build the remap table after power-up, in which no data is written without an associated table entry element, which can be achieved at no additional performance or write endurance penalty; and
wherein recovery of the table includes recovery of information about blocks which were scheduled for erasures but not yet implemented, as well as information about whether or not a block has valid data

27. (canceled)

28. (cancelled)

29. The emulation system as claimed in claim 1, wherein the programming system is adapted to extract parameters from an existing device interrogation response according to rules dedicated to different types of interogation responses, and to use the extracted parameters to perform programming of the programmable device, and wherein the programmable device is adapted to re-create a response from said parameters, said response mimicing the original device response.

30. (canceled)

31. A solid state storage device comprising non-volatile memory, volatile memory, and a control circuit, wherein the control circuit is adapted to implement a remap table which maps host computer logical addresses to physical addresses in the non-volatile memory; and
wherein the remap table has levels of granularity which are larger, the same size, or smaller than a non-volatile memory block size so that the remap table size is de-coupled from the capacity of the non-volatile memory, and wherein granularity extends downwards to a point where there is a table entry for every non-volatile memory sector.

32. (canceled)

33. The solid state storage device as claimed in claim 31,
wherein the device includes a cache memory which has a structure with a remap table granularity and is the form of a ring buffer, and is adapted to make entries to the head of the ring, and to remove data from the tail as the buffer becomes close to full or as an impending power-down has been detected, and to perform a write of the sectors involved to the non-volatile memory, and to write a flag to the remap table descriptor that such a write occurred, indicating that this data is in non-volatile memory.

34. The solid state storage device as claimed in claim 31, wherein a physical address in the remap table refers to either a non-volatile memory address when data is in the non-volatile memory or to a volatile memory address when data is in cache, and wherein said physical address is used to locate the cache entry when data is in cache such that control flags are marked to invalidate older cache entries as new entries are made for those logical addresses to the head of the cache.

35. The solid state storage device as claimed in claim 31, wherein if a subsequent write is made to any area within a remap table entry of non-volatile memory which indicates that such area has been previously written at least in part, an entry is made in a descriptor to schedule a future erase operation.

36. The solid state storage device as claimed in claim 31, wherein the device is adapted to create a per-block usage table with a valid bit per segment in that block to indicate which segment has valid data, along with a program/erase-count field for use by a wear-levelling algorithm.

37. The solid state storage device as claimed in claim 31, wherein the device is adapted to write vital control information including logical addresses and for-erasure and valid flags, to a non-volatile memory spare area as part of normal write operations, coupled with a scan through the spare area following power-up, which may follow either a planned or an unexpected power-down, to re-construct the key remap tables and other vital information; and
wherein the device is adapted to use linked-lists of previous mapped addresses and their program/erase-count numbers invoked with every normal data write to non-volatile memory, and an associated recovery mechanism, such that the non-volatile memory always contains the most recent information needed to rebuild the complete re-map table after power-down, whether expected or unexpected.

38. (canceled)

39. The solid state storage device as claimed in claim 31, wherein the device is adapted to use timestamps or sequence numbers invoked with every normal data write to non-volatile memory, and an associated recovery mechanism, such that the non-volatile memory always contains the most recent information needed to rebuild the complete re-map table after power-down, whether expected or unexpected.
